(19) United States
(12) Patent Application Publication
(10) Pub. No.: US 2010/0122915 A1
(43) Pub. Date: May 20, 2010

(54) METHODS OF SCREENING CATHODE ACTIVE MATERIALS

(76) Inventors: Nikolay K. Iltchev, Norfolk, MA (US); George M. Cintra, Holliston, MA (US)

Correspondence Address: FISH & RICHARDSON P.C., P.O. BOX 1022, MINNEAPOLIS, MN, 55440-1022, US

(21) Appl. No.: 12/274,629

(22) Filed: Nov. 20, 2008

(51) Int. Cl. G01N 27/26

(52) U.S. Cl. 205/794.5; 205/775

(57) ABSTRACT

Electrochemical methods of evaluating battery active materials, such as cathode active materials, are provided.

### TECHNICAL FIELD

The invention relates to batteries, as well as to related components and methods.

### BACKGROUND

Batteries or electrochemical cells are commonly used electrical energy sources. A battery, such as an alkaline battery, contains a negative electrode, typically called the anode, and a positive electrode, typically called the cathode. The anode contains an active material that can be oxidized; the cathode contains or consumes an active material that can be reduced. The anode active material is capable of reducing the cathode active material.

In alkaline batteries such as NiOOH—Zn primary batteries, the cathode can include an active material such as nickel oxyhydroxide, the cathode can further include carbon particles that enhance the conductivity of the cathode, and a binder. The anode can be formed of a gel including zinc particles. A separator is disposed between the cathode and the anode. An alkaline electrolyte solution, which is dispersed throughout the battery, can be a hydroxide solution such as potassium hydroxide. When a battery is used as an electrical energy source in a device, electrical contact is made to the anode and the cathode, allowing electrons to flow through the device and permitting the respective oxidation and reduction reactions to occur to provide electrical power. The electrolyte in contact with the anode and the cathode contains ions that flow through the separator to maintain charge balance throughout the battery during discharge.

Alkaline batteries such as NiOOH/Zn batteries can have relatively high load voltage and good rate capabilities, and are amenable to high drain applications, such as use in digital cameras. The performance of freshly made alkaline batteries can decrease upon storage. To measure the performance in both stored and fresh batteries, in-cell tests can be conducted, where an electrochemical cell is assembled and discharged for electrochemical performance. However, the in-cell characterization technique can require large amounts of a test material and/or can be relatively labor intensive. In addition, as the in-cell characterization is a two-electrode cell system including a cathode and an anode, one electrode's performance (e.g., the cathode performance) cannot be completely separated from the total battery performance, which includes the counter electrode's performance (e.g., the anode performance). Due to contributing effects from the counter electrode, and parasitic reactions such as battery can corrosion and separator resistance, resolution of the performance of only one electrode (e.g., the cathode) can be subtle, and comparison between electrode active materials having similar performance can be difficult. Further, as there is no stable reference voltage in a two-electrode evaluation cell, the electrochemical characterization of one electrode's active material is evaluated relative to a counter electrode's active material. In situations where the counter electrode changes its potential, for example, during storage and/or during discharge due to buildup of interfering species (e.g., buildup of ZnO on a Zn electrode), evaluation of the performance of the electrode active material can be inaccurate.

### SUMMARY

Generally, the invention relates to methods for measuring the electrochemical properties of a sample of one or more battery active materials, both freshly made or stored for a period of time at a desired temperature. This invention also relates to methods of identifying a stable active material for a battery.

The methods use a three-electrode characterization method, in which a linear sweep voltammetric measurement can be conducted on a working electrode that includes an amount of a battery active material. The three-electrode approach can be relatively rapid and sensitive, and can advantageously be used with very small samples of battery active materials.

In one aspect, the invention features methods for comparing stability for a plurality of cathode active materials. The methods include, for each cathode active material in the plurality of cathode active materials: disposing the cathode active material in a test cell including a reference electrode including mercury and mercury oxide, and a working electrode including the cathode active material; conducting a linear sweep reduction voltammetric measurement; and plotting a normalized current to voltage voltammogram. The methods further include comparing the voltammograms for the plurality of cathode active materials.

In another aspect, the invention features methods of identifying a stable cathode active material for a battery. The methods include disposing a cathode active material in a test cell including a reference electrode including mercury and mercury oxide, and a working electrode including the cathode active material; conducting a linear sweep reduction voltammetric measurement; and plotting a normalized current to voltage voltammogram. The stable cathode active material has an absolute positive potential peak value of greater than or equal to 0.1V versus mercury/mercury oxide.

In another aspect, the invention features methods for comparing stability for a plurality of cathode active materials. The methods include, for each cathode active material in the plurality of cathode active materials: disposing the cathode active material in a test cell including a reference electrode including mercury and mercury oxide, and a working electrode including the cathode active material; conducting a linear sweep oxidation voltammetric measurement; and plotting a normalized current to voltage voltammogram. The methods further include comparing the voltammograms for the plurality of cathode active materials.

In yet another aspect, the invention features methods for comparing stability for a plurality of cathode active materials. The methods include, for each cathode active material in the plurality of cathode active materials: disposing the cathode active material in a test cell including a reference electrode including mercury and mercury oxide and a working electrode including the cathode active material; conducting a linear sweep reduction voltammetric measurement; plotting a normalized current to voltage voltammogram; and calculating an absolute capacity from the voltammogram. The methods further include comparing the absolute capacities for the plurality of cathode active materials.

Embodiments can include one or more of the following features.

In some embodiments, in a linear sweep reduction voltammetric measurement, each voltammogram includes a positive potential peak having an absolute positive potential peak value. A more stable cathode active material can have a larger absolute positive potential peak current value.

In some embodiments, in a linear sweep oxidation voltammetric measurement, each voltammogram includes an oxidation curve. A more stable cathode active material can have an oxidation curve having an absolute current value of less than 9×10⁻⁶ A/g between 0.4V and 0.5V versus mercury/mercury oxide.

In some embodiments, the methods further include calculating a capacity of the cathode active material from the normalized current to voltage voltammogram (e.g., a reduction or oxidation voltammogram). A more stable cathode active material can have a larger absolute capacity value.

In some embodiments, the linear sweep reduction and/or oxidation measurement has a sweep rate of at least 0.001 mV/s and at most 30 mV/s.

In some embodiments, the test cell further includes a counter electrode including platinum.

In some embodiments, the working electrode is stored at a temperature of at least 55° C. (e.g., at least 60° C. or at least 70° C.) for a duration of at least two days (e.g., at least three days, at least one week, or at least two weeks) prior to measurement. The working electrode can be stored in an electrolyte solution. In some embodiments, the working electrode is freshly made (e.g., within one hour, within three hours, within seven hours, or within 12 hours) prior to measurement.

In some embodiments, the working electrode includes at least 10 mg and/or at most 300 mg of the cathode active material. The cathode active material can be on an expanded metal grid current collector. The cathode active material can include NiOOH. The cathode active material can further include cobalt, for example, on a surface of the cathode active material and/or in an interior of the cathode active material. In some embodiments, the cathode active material is fresh or stored. In some embodiments, the working electrode further includes a conducting aid, such as acetylene black, graphite, teflonized acetylene black, and/or expanded graphite.

In some embodiments, the plurality of cathode active materials includes a first cathode active material and a second cathode active material. The first and second cathode materials, independently, can be fresh or stored.

The battery can be a NiOOH—Zn battery. The methods can further include incorporating the stable cathode active material into the battery (e.g., a primary battery).

Embodiments can include one or more of the following advantages.

The methods can be relatively rapid and sensitive, can be conducted on a small amount of an analyte (e.g., a cathode active material), and can be relatively easily performed and implemented. The methods can be relatively accurate. For example, the performance of an analyte can be assessed without interfering factors, such as contributing effects from a counter electrode (e.g., when the counter electrode changes its potential), buildup of interfering species (e.g., buildup of ZnO on a Zn electrode), and/or parasitic reactions such as battery can corrosion and separator resistance during storage and/or during discharge, some or all of which can be present in conventional in-cell evaluation methods. Further, the methods can provide more than one way of analyzing the analyte (e.g., by oxidizing the analyte, by reducing analyte) to provide greater amounts of information about the performance of the fresh and stored analyte.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram showing a three-electrode electrochemical assembly.

FIG. 2 is a graph showing reduction current profiles of four cathode active materials stored for one week at 60° C.

FIG. 3 is a graph showing oxidation current profiles of four fresh cathode active materials.

FIG. 4 is a graph showing reduction current profiles of four fresh cathode active materials.

FIG. 5 is a graph showing reduction current profiles of two cathode active materials, both fresh and stored for one week at 60° C.

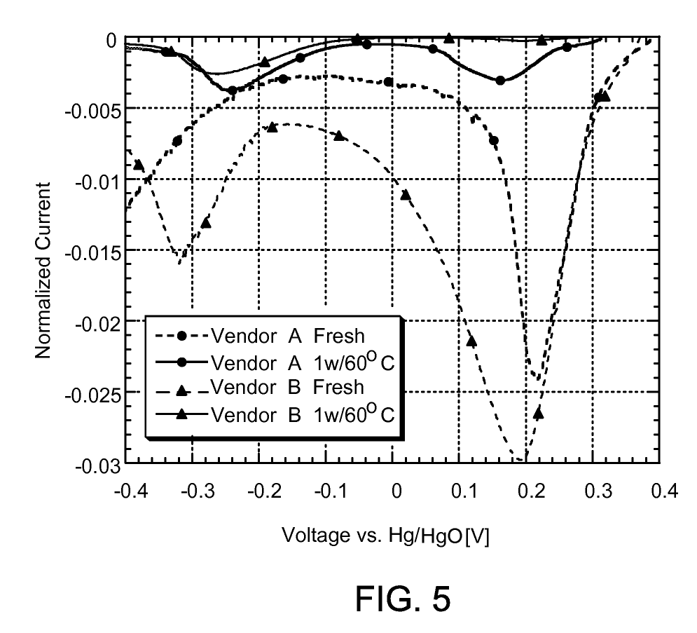

### DETAILED DESCRIPTION

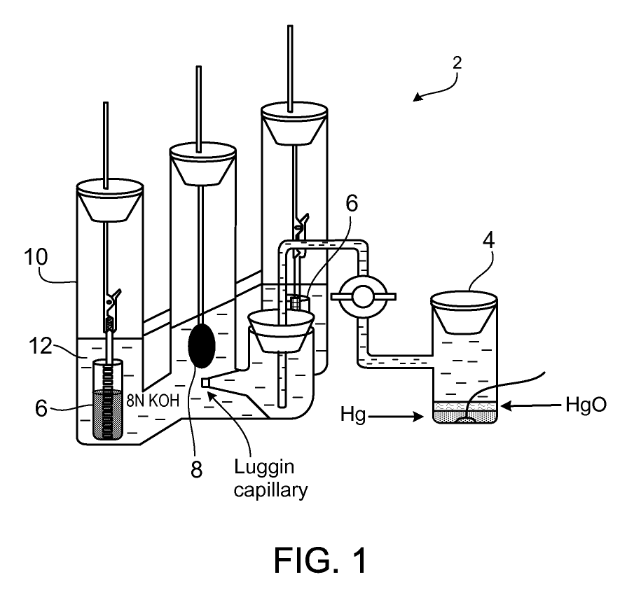

Referring to FIG. 1, a battery active material, such as a cathode active material, is tested in an out-of-cell three electrode assembly 2. The assembly includes a reference electrode 4, one or more auxiliary electrodes 6, a working electrode 8 such as a battery cathode that includes an analyte (e.g., a cathode active material to be tested). The reference electrodes, auxiliary electrodes, and working electrode can be contained within a double H-glass cell 10, which further contains an electrolyte 12. The assembly is electronically connected to a potentiostat, which is in turn coupled to a computer interface.

The analyte (e.g., a cathode active material) can be evaluated by subjecting the working electrode after a period of storage to a linear sweep voltammetric measurement, plotting a normalized current to voltage voltammogram, and analyzing the voltammogram. By comparing the voltammograms for a variety of cathode active materials, a cathode active material having superior stability (e.g., thermal stability) and performance can be identified. The evaluation method can be relatively rapid and sensitive, can be conducted on a small amount of analyte, and can be relatively easily performed and implemented.

In some embodiments, the working electrode is preassembled and stored for a period of time at a given temperature (e.g., at 60° C. for one week) before evaluation of the analyte. The working electrode can be stored in an electrolyte under inert atmosphere. For example, the working electrode can be stored for a duration of from 12 hours to 24 hours (e.g., from one day to seven days, or from one week to two weeks). As an example, the working electrode can be stored at a temperature of between 30-80° C. (e.g., between 35-75° C., between 40-60° C., between 50-60° C., or between 55-60° C.). In some embodiments, the working electrode is stored at 40° C.±2° C. (e.g., at 50° C.±2° C., at 60° C.±2° C., or at 70° C.±2° C.). In some embodiments, the working electrode is stored for at least two days (e.g., at least three days, at least one week, or at least two weeks) at a temperature of at least 40° C. (at least 50° C., at least 55° C., at least 60° C., or at least 70° C.). The temperature of storage can vary over the storage duration. In some embodiments, the working electrode is not stored prior to measurement, rather, it is freshly prepared (e.g., within one hour, within three hours, within seven hours, or within 12 hours) prior to measurement.

Prior to measurement, the working electrode can be tempered to room temperature, removed from storage, and placed into a flooded double H-glass cell. A potentiodynamic sweep can be conducted using a potentiostat coupled to a computer interface, for example, a Princeton Applied Research potentiostat model 272A (available from Perkin Elmer), coupled to a CorrWare interface (available from 2000 Scribner Associates, Inc.). The potentiodynamic measurements can be conducted under inert atmosphere and/or at a given temperature (e.g., at room temperature, at 30° C., or at 60° C.).

The potentiodynamic sweep can be either reductive or oxidative. In a reductive potentiodynamic sweep, the working electrode potential is ramped down from an open circuit voltage of the analyte down to a desired voltage at a given scan rate. For example, when the analyte is NiOOH, the potential scan can start at around an open circuit potential of about 0.35V and end at around −0.6V for a reductive potentiodynamic sweep. As another example, when the analyte is NiOOH in an oxidative potentiodynamic sweep, the potential scan can start at around an open circuit potential of about 0.35V and end at around 0.575V.

The scan rate can be at least 0.001 mV/second (e.g., at least 0.01 mV/s, at least 0.1 mV/s, at least 1 mV/s, at least 10 mV/s, or at least 20 mV/s) and/or at most 30 mV/second (e.g., at most 20 mV/s, at most 10 mV/s, at most 1 mV/s, at most 0.1 mV/s, or at most 0.01 mV/s). In some embodiments, the scan rate is correlated to the signal to noise ratio of the resulting voltammogram, such that a slower scan rate that requires a longer duration for the scan can produce a voltammogram having a higher signal to noise ratio. The signal to noise ratio can be balanced with the duration of each potentiodynamic scan such that a voltammogram having low signal to noise ratio is generated within a reasonable amount of time. In some embodiments, the scan rate is about 1 mV/s.

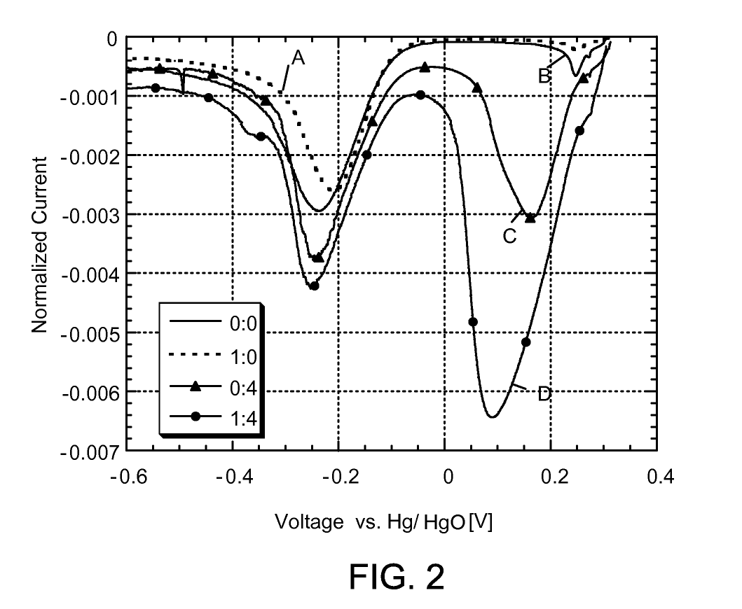

As an example, referring to FIG. 2, voltammograms having positive potential peaks situated at between 0 and 0.35 V can result from a reductive potentiometric sweep for four working electrodes, each having a different analyte (a NiOOH active material) and measured against a mercury/mercury oxide reference electrode. Each working electrode includes the same amount by weight of the NiOOH active material, such that the generated voltammograms are normalized with respect to the amount of active material. Each peak has an absolute positive potential peak value, and the analyte having the largest absolute positive potential peak value (e.g., largest absolute current value) indicates a stable analyte that has retained the most performance after storage. For example, referring to FIG. 2, voltammogram D has the largest absolute positive potential peak value, and indicates an analyte that has sustained the least storage loss.

In some embodiments, a shift along the x-axis (voltage vs. Hg/HgO) in the positive potential peak value can indicate a change in a load voltage of the analyte. For example, referring to FIG. 2, voltammogram A has the highest initial load voltage, while voltammogram D has the lowest initial load voltage. In some embodiments, an analyte (e.g., a cathode active material) having an absolute positive potential peak value of at least 0.1V relative to a mercury/mercury oxide reference electrode is considered to be a stable cathode active material.

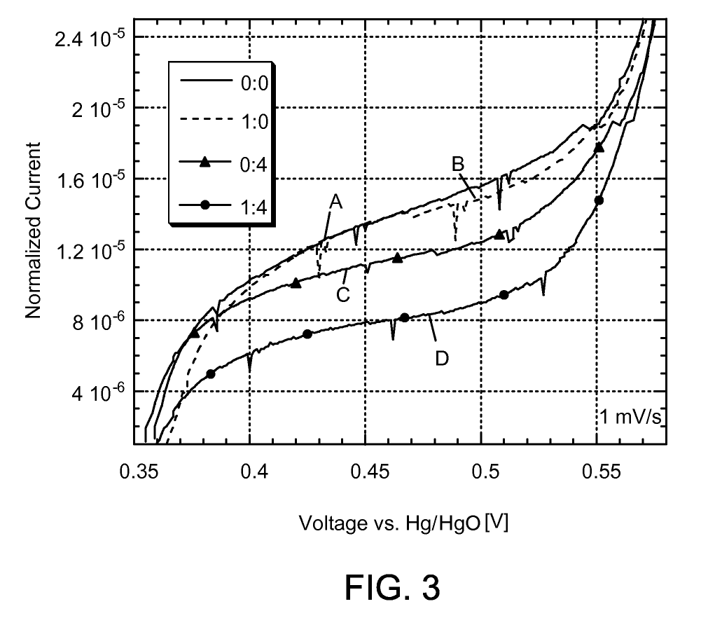

As another example, referring to FIG. 3, voltammograms having potential curves situated at between 0.35V and 0.575V can result from a oxidative potentiometric sweep for four working electrodes, each having a same amount per weight of a different analyte (a NiOOH active material) and measured against a mercury/mercury oxide reference electrode. The working electrodes can be freshly prepared, or can be stored at a desired temperature for a duration of time. Each oxidative curve has an absolute current value, and the analyte having the smallest absolute current value between 0.4V and 0.5V vs. the reference electrode has retained the most performance after storage. For example, referring to FIG. 3, voltammogram D has the smallest absolute current value between 0.4V and 0.5V, and indicates that the analyte corresponding to voltammogram D would sustain the least storage loss. In some embodiments, an absolute current value of less than 9×10⁻⁶ between 0.4V and 0.5V vs. a Hg/HgO reference electrode indicates a stable cathode active material. The oxidative potentiometric sweep evaluates the stability of the analytes on oxidation, where the more stable analyte has better performance on storage.

In some embodiments, both fresh performance and performance after storage are compared for a given analyte. The capacity of the analyte can be calculated from integrating the area under the voltammogram curves for a reductive potentiometric sweep. The capacities of different analytes, or of freshly synthesized and stored analytes can be compared to identify relatively stable analytes having good performance. The analyte having the largest capacity can indicate a greater stability.

In some embodiments, the stable cathode active material is then incorporated into a battery (e.g., a NiOOH/Zn battery).

### Composition of Components of the Three-Electrode Assembly

In some embodiments, the reference electrode includes a mercury/mercury oxide half cell having a known constant potential. The constant potential can serve as a reference in measuring and controlling the working electrode's potential. The auxiliary electrodes can include glassy carbon, platinum, and/or gold, and can balance the current observed at the working electrode. The working electrode can apply a desired potential in a controlled manner and can transfer electrons to and from the analyte (e.g., the cathode active material).

In some embodiments, the working electrode includes a current collector and an analyte composition that is coated on at least one side of the cathode current collector. The analyte composition can include one or more analytes (e.g., one or more cathode active materials), and can also include one or more conductive materials (e.g., conductive aids, charge control agents) and/or one or more binders as part of the composition. The analyte composition can be coated onto the current collector by pressing the composition onto a current collector. In some embodiments, the cathode active material includes NiOOH, such as NiOOH particles having Co on the particle surface and/or in the particle interior. The cathode active material can be used, for example, in a NiOOH—Zn battery.

The cathode current collector can be formed, for example, of one or more metals and/or metal alloys. Examples of metals include titanium, nickel, and aluminum. Examples of metal alloys include aluminum alloys (e.g., 1N30, 1230, 1145, 1235) and stainless steel. The current collector generally can be in the form of a foil or a grid (e.g., an expanded metal grid). The foil can have, for example, a thickness of up to about 35 microns and/or at least about 10 microns.

The working electrode can contain a relatively small amount of analyte (e.g., an active material such as a cathode active material). For example, the working electrode can include at most 300 mg (e.g., at most 250 mg, at most 200 mg, at most 150 mg, at most 100 mg, at most 75 mg, or at most 50 mg) and/or at least 10 mg (e.g., at least 50 mg, at least 75 mg, at least 100 mg, at least 150 mg, at least 200 mg, or at least 250 mg) of analyte. In some embodiments, the working electrode can include between 10 mg and 300 mg (e.g., between 50 mg and 200 mg, between 50 mg and 150 mg, or between 100 and 150 mg) of analyte.

The conductive materials can enhance the electronic conductivity of cathode 16 within electrochemical cell 10. Examples of conductive materials include conductive aids and charge control agents. Specific examples of conductive materials include carbon black, graphitized carbon black, acetylene black, teflonized acetylene black, expanded graphite, and graphite. The cathode material includes, for example, at least about 3% by weight and up to about 8% by weight of one or more conductive materials.

The binders can help maintain homogeneity of the cathode material and can enhance the stability of the cathode. Examples of binders include linear di- and tri-block copolymers. Additional examples of binders include linear tri-block polymers cross-linked with melamine resin; ethylene-propylene copolymers; ethylene-propylene-diene terpolymers; tri-block fluorinated thermoplastics; fluorinated polymers; hydrogenated nitrile rubber; fluoro-ethylene-vinyl ether copolymers; thermoplastic polyurethanes; thermoplastic olefins; styrene-ethylene-butylene-styrene block copolymers; and polyvinylidene fluoride homopolymers. The cathode material includes, for example, at least about 1% by weight and/or up to about 6% by weight of one or more binders.

The electrolyte in the 3-electrode assembly or during storage can include a variety of solvents. In some embodiments, the electrolyte is an aqueous KOH solution having a concentration between 7-11N (e.g., 7N, 8N, 9N, 10N, 11N). In some embodiments, the electrolyte can include an organic solvent such as propylene carbonate (PC), ethylene carbonate (EC), dimethoxyethane (DME) (e.g., 1,2-dimethoxyethane), butylene carbonate (BC), dioxolane (DX), tetrahydrofuran (THF), gamma-butyrolactone, diethyl carbonate (DEC), dimethyl carbonate (DMC), ethyl methyl carbonate (EMC), dimethylsulfoxide (DMSO), methyl formiate (MF), sulfolane, or a combination (e.g., a mixture) thereof. In certain embodiments, the electrolyte can include an inorganic solvent, such as SO₂ or SOCl₂.

In some embodiments, the electrolyte includes one or more salts (e.g., two salts, three salts, four salts). Examples of salts include lithium salts, such as lithium trifluoromethanesulfonate (LiTFS), lithium trifluoromethane-sulfonimide (LiTFSI), lithium iodide (LiI), and lithium hexafluorophosphate (LiPF₆). Additional lithium salts that can be included are described, for example, in Suzuki, U.S. Pat. No. 5,595,841. Other salts that can be included in the electrolyte are bis(oxalato)borate salts (e.g., (LiB(C₂O₄)₂)) and lithium bis(perfluoroethyl)sulfonimide (LiN(SO₂C₂F₅)₂). Bis(oxalato)borate salts are described, for example, in Totir et al., U.S. Patent Application Publication No. US 2005/0202320 A1, published on Sep. 15, 2005, and entitled “Non-Aqueous Electrochemical Cells”. The electrolyte includes, for example, at least about 0.1 M (e.g., at least about 0.5 M or at least about 0.7 M) and/or up to about 2 M (e.g., up to about 1.5 M or up to about 1.0 M) of the lithium salts.

In some embodiments, the electrochemical cell is a double H-glass cell, or separate cylindrical cells, connected by an electrolyte bridge or valves.

The following examples are meant to be illustrative and not to be limiting.

### EXAMPLE 1

A 150 mg sample of NiOOH material was homogeneously dry-mixed with 350 mg teflonized acetylene black (TAB-2, Hohsen Corporation, Japan). The test cathode was prepared by pressing (5 metric tons per 1.8 cm²) on a nickel x-met current collector 100 mg of the 30/70 (NiOOH/TAB-2) cathode mix in a 15 mm diameter die. Under inert atmosphere, the cathode was placed in a glass vial filled with 9N aqueous KOH out-gassed for 15 minutes using argon gas (prior to placing the cathode). The hermetically sealed glass vial with the cathode and the electrolyte was stored for one week at 60° C.±2° C.

After tempering to room temperature, the cathode was taken out of the glass vial and was placed into a flooded double H-glass cell, having two platinum auxiliary and a Hg/HgO reference electrodes, under inert atmosphere. A reduction potentiodynamic sweep from an open circuit voltage of about 0.35V to a voltage of −0.6V (vs. Hg/HgO) was performed using a Princeton Applied Research Potentiostat model 272A (Perkin Elmer, previously EG&G), coupled to a CorrWare interface (2000 Scribner Associates Inc.). A 1 mV/s potential sweep was used.

In all experiments, cathodes with the same weight amount of the active material were used, such that comparison of different materials on one graph was possible since the current was already normalized by weight of the active material.

FIG. 2 shows voltammograms for commercial NiOOH samples from the same commercial source, but with different surface and bulk (e.g., interior) cobalt contents. As shown in FIG. 2, the best storage characteristics were obtained with materials having 1% bulk and 4% surface Co coating. A sample having 0% bulk and 4% surface Co coating had superior stability when compared to samples having 0%:0%, 1%:0%, and 0%:4% bulk to surface Co contents. NiOOH samples with lower Co content (1%:0% and 0%:0%) incurred significant storage losses, indicated by the near disappearance of the positive potential peak at about 0.25V relative to Hg/HgO. Therefore, FIG. 2 shows that a Co surface coating can increase material stability. FIG. 2 also shows that Co surface coating can also lower load voltage as shown by a shift of the positive potential peak to lower voltage values (e.g., from about 0.25V for 0% surface coating to about 0.14 or about 0.9V for 4% surface coating).

Prediction of in-cell storage for various cathode active materials is possible by interpreting the data from FIG. 2. For example, a NiOOH having 1%:4% bulk to surface Co content can have excellent in-cell storage, a NiOOH having 0%:4% bulk to surface Co content can have good in-cell storage, while NiOOH having 1%:0% and 0%:0% bulk to surface Co content can have inferior performance in an in-cell test. The out-of-cell evaluation was later confirmed in an AA in-cell test, and followed the prediction of the linear sweep voltammetry characterization.

### EXAMPLE 2

Cathodes were prepared as described in Example 1. The cathodes were not stored at elevated temperatures, and a voltammetric sweep was performed on oxidation. Referring to FIG. 3, a 1 mV/s oxidation sweep from the open circuit voltage of about 0.35V to a voltage of 0.575V for four cathodes were shown. The four cathodes each had 0%:0%, 1%:0%, 0%:4%, and 1%:4% bulk to surface Co content. As seen by the oxidation curves which have higher current values between 0.4V and 0.5V, NiOOH materials with the lowest percent Co content (e.g., 0%:0% and 1%:0%) were more sensitive to oxygen evolution, compared to cathodes with higher Co content (0%:4% and 1%:4% respectively). FIG. 3 confirmed the results from Example 1, and showed that NiOOH having higher Co content provided a material that was more robust to oxidation and/or decomposition accompanied by oxygen evolution.

### EXAMPLE 3

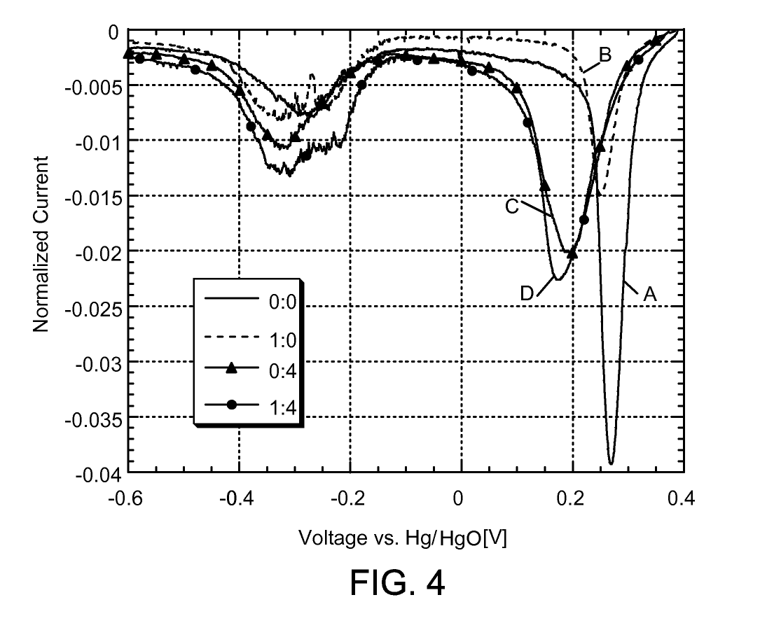

Comparison of freshly prepared cathode active materials was carried out. FIG. 4 shows a 1 mV/s sweep of freshly prepared cathodes of the same composition as Examples 1 and 2. The four positive potential peaks in the range of 150 to 300 mV were divided into two groups. Samples with lower Co content (0:0 and 1:0) were located in the 250-300 mV potential range, and materials with higher Co content (0:4 and 1:4) showed positive potential peaks in the 150-200 mV voltage window. Negative potential peaks for all four materials were positioned in the −200 to −400 mV range.

Comparison of FIG. 3 (fresh cathodes) and FIG. 1 (stored cathodes) showed that storage did not have significant impact on the −200 to −400 mV negative potential peaks. However, storage resulted in large changes in the positive potential peak, which can be used for identification of the best cathode active material. For example, samples with lower Co content (0:0 and 1:0) have much reduced positive potential peaks upon storage, while higher Co content materials (0:4 and 1:4) underwent less dramatic changes. Thus, optimum stability evaluation results could obtained by monitoring the positive potential peaks.

### EXAMPLE 4

Stability evaluation of two NiOOH-containing materials from two different commercial sources was carried out. Both fresh and stored cathodes were prepared as described in Example 1. The fresh positive potential peak of a cathode active material from vendor A was >0.2V, and that of a cathode active material from vendor B was <0.2V. After storage, the cathode active material from vendor A still had a positive potential peak, while the positive potential peak for the cathode active material from vendor B disappeared. Thus, the cathode active material from vendor A would provide better fresh and stored performance compared to the cathode active material from vendor B. The evaluation results were confirmed using an in-cell AA battery test.

A number of embodiments of the invention have been described. Nevertheless, it will be understood that various modifications may be made without departing from the spirit and scope of the invention. For example, while a linear sweep voltammetric method is described herein, other voltammetry methods are possible, such as cyclic voltammetry methods. While methods of identifying stable cathode active materials, such as NiOOH materials, are described, in some embodiments, similar methods can be adapted for identification of other stable cathode active materials and/or stable anode materials. Characteristics of the analytes obtained from the three-electrode assembly can be confirmed using in-cell tests.

Other embodiments are within the scope of the following claims.

What is claimed is:

1. A method for comparing stability for a plurality of cathode active materials, comprising:
for each cathode active material in the plurality of cathode active materials:
disposing the cathode active material in a test cell comprising a reference electrode comprising mercury and mercury oxide, and a working electrode comprising the cathode active material,
conducting a linear sweep reduction voltammetric measurement, and
plotting a normalized current to voltage voltammogram; and
comparing the voltammograms for the plurality of cathode active materials.

2. The method of claim 1, wherein each voltammogram includes a positive potential peak having an absolute positive potential peak value.

3. The method of claim 2, wherein a more stable cathode active material has a larger absolute positive potential peak value.

4. The method of claim 1, wherein the test cell further comprises a counter electrode comprising platinum.

5. The method of claim 1, wherein the cathode active material comprises NiOOH.

6. The method of claim 5, wherein the cathode active material further comprises cobalt.

7. The method of claim 6, wherein the cobalt is on a surface of the cathode active material.

8. The method of claim 6, wherein the cobalt is in an interior of the cathode active material.

9. The method of claim 1, wherein the working electrode is stored at a temperature of at least 55° C. for a duration of at least 2 days prior to measurement.

10. The method of claim 9, wherein the working electrode is further stored in an electrolyte solution.

11. The method of claim 1, wherein the working electrode is prepared within about three hours prior to measurement.

12. The method of claim 1, wherein the working electrode further comprises a conducting aid.

13. The method of claim 12, wherein the conducting aid is selected from the group consisting of acetylene black, graphite, teflonized acetylene black, and expanded graphite.

14. The method of claim 1, wherein the working electrode comprises at least 10 mg of the cathode active material.

15. The method of claim 1, wherein the working electrode comprises at most 300 mg of the cathode active material.

16. The method of claim 1, wherein the working electrode comprises the cathode active material on an expanded metal grid current collector.

17. The method of claim 1, wherein the plurality of cathode active materials comprises a first cathode active material and a second cathode active material.

18. The method of claim 17, wherein the first cathode active material is a fresh cathode active material.

19. The method of claim 17, wherein the second cathode active material is a stored cathode active material.

20. The method of claim 1, wherein the measurement has a sweep rate of at least 0.001 mV/s and at most 30 mV/s.

21. The method of claim 1, further comprising calculating a capacity of the cathode active material from the normalized current to voltage voltammogram.

22. A method of identifying a stable cathode active material for a battery, comprising:
disposing a cathode active material in a test cell comprising a reference electrode comprising mercury and mercury oxide, and a working electrode comprising the cathode active material;
conducting a linear sweep reduction voltammetric measurement; and
plotting a normalized current to voltage voltammogram,
wherein the stable cathode active material has an absolute positive potential peak value of greater than or equal to 0.1V versus mercury/mercury oxide.

23. The method of claim 22, further comprising storing the working electrode at a temperature of at least 55° C. for a duration of at least 2 days prior to measurement.

24. The method of claim 22, wherein the test cell further comprises a counter electrode comprising platinum.

25. The method of claim 22, wherein the cathode active material comprises NiOOH.

26. The method of claim 22, wherein the battery is a NiOOH—Zn battery.

27. The method of claim 22, further comprising incorporating the stable cathode active material into the battery.

28. A method for comparing stability for a plurality of cathode active materials, comprising:
for each cathode active material in the plurality of cathode active materials:
disposing the cathode active material in a test cell comprising a reference electrode comprising mercury and mercury oxide and a working electrode comprising the cathode active material,
conducting a linear sweep oxidation voltammetric measurement, and
plotting a normalized current to voltage voltammogram; and
comparing the voltammograms for the plurality of cathode active materials.

29. The method of claim 28, wherein each voltammogram includes an oxidation curve.

30. The method of claim 29, wherein a more stable cathode active material has an oxidation curve having a absolute current value less than 9×10⁻⁶ A/g between 0.4V and 0.5V versus mercury/mercury oxide.

31. The method of claim 28, wherein the test cell further comprises a counter electrode comprising platinum.

32. The method of claim 28, wherein the cathode active material comprises NiOOH.

33. A method for comparing stability for a plurality of cathode active materials, comprising:
for each cathode active material in the plurality of cathode active materials:
disposing the cathode active material in a test cell comprising a reference electrode comprising mercury and mercury oxide and a working electrode comprising the cathode active material,
conducting a linear sweep reduction voltammetric measurement,
plotting a normalized current to voltage voltammogram, and
calculating an absolute capacity from the voltammogram; and
comparing the absolute capacities for the plurality of cathode active materials.

34. The method of claim 33, wherein a more stable cathode active material has a larger absolute capacity value.

35. The method of claim 33, wherein the test cell further comprises a counter electrode comprising platinum.

36. The method of claim 33, wherein the cathode active material comprises NiOOH.
